(19) United States
(12) Patent Application Publication
(10) Pub. No.: US 2015/0262259 A1
(43) Pub. Date: Sep. 17, 2015

(54) Coupon Generator

(71) Applicant: Robert MOULTON-ELY, Lake Forest, IL (US)

(72) Inventor: Robert MOULTON-ELY, Lake Forest, IL (US)

(21) Appl. No.: 14/660,221

(22) Filed: Mar. 17, 2015

Related U.S. Application Data
(60) Provisional application No. 61/954,278, filed on Mar. 17, 2014.

(51) Int. Cl. G06Q 30/02; G06F 17/30

(52) U.S. Cl. CPC G06Q 30/0276; G06Q 30/0277; G06F 17/30876

(57) ABSTRACT

A coupon generator system according to the present invention may include a coupon generator, a database, a calendar generator, and a flash coupon generator. The coupon generator may be configured to receive coupon information from a user and generate coupon images and information regarding coupons. The database may be configured to receive images and information from the coupon generator and provide access to the data to other components of the system. The calendar generator may be configured to draw information and images from the database and generate a publicly-accessible calendar with coupons. The flash coupon generator may be configured to draw information from the database and generate flash coupon files for print media. Preferably, the system comprises a web server coupled to the Internet. The system may further include an on-line community calendar configured to receive content from the calendar generator.

This application claims priority to and incorporates by reference U.S. Provisional Patent Application No. 61/954,278 filed Mar. 17, 2014 and titled “Coupon Wizard”

### FIELD OF THE INVENTION

This invention relates to the creation of digital coupons to be placed on an online virtual calendar that any newspaper subscribers can browse through and print.

### BACKGROUND

Advertisers often rely on coupons to promote selected goods and/or services. Advertisers generally desire to have their coupons receive timely and widespread exposure. However, periodical publishing is now spread over different media, including print and on-line publication, complicating the publication of coupons.

### SUMMARY

One example of the present invention relates to a system and method for (a) the creation of small coupon graphics (“Splashes” defined below) to be placed automatically in a periodical publication, such as a newspaper's (“Periodical”) online and mobile calendar; (b) the creation of Splashes to be placed automatically in a Periodical's online and mobile coupon page; (c) the creation of small coupon graphics (“Flashes” defined below) added automatically to a zip file that contains other Flashes as well as traditional human-created advertising, editorial and photos needed for a printed Periodical; (d) the creation of printable complete coupons that can be accessed by clicking on the online or mobile Splashes; and (e) associated tracking, accounting and control features.

A coupon generator system according to the present invention may include a coupon generator, a database, a calendar generator, and a flash coupon generator. The coupon generator may be configured to receive coupon information from a user and generate coupon images and information regarding coupons. The database may be configured to receive images and information from the coupon generator and provide access to the data to other components of the system. The calendar generator may be configured to draw information and images from the database and generate a publicly-accessible calendar with coupons. The flash coupon generator may be configured to draw information from the database and generate flash coupon files for print media. Preferably, the system comprises a web server coupled to the Internet. The system may further include an on-line community calendar configured to receive content from the calendar generator.

The coupon generator may be configured to receive coupon specific information from a user, draw customer-specific information from the database, and combine textual information with a coupon image blank to create a coupon. The flash coupon files may comprise PDF files.

With the coupon generator, the Advertiser can self-generate and automatically disseminate its coupons to the Periodical's online and mobile calendar, online and mobile coupon page, online and mobile content and paper-and-ink-printed media. The coupon generator allows Advertisers complete flexibility to quickly and timely create coupons that will reach the Periodical's entire reader-base with little or no need for Periodical's staff (“Staff”) time.

### BRIEF DESCRIPTION OF DRAWINGS

FIG. 1 illustrates a block diagram of a coupon generator system according to one aspect of the present invention.

FIG. 2 illustrates a flow diagram of a coupon generating method according to another aspect of the present invention.

### DETAILED DESCRIPTION OF INVENTION

A periodical publication, such as a newspaper, may have both print edition and on-line editions. Periodicals may also publish community calendars, including various community events. In one example of the present invention, the periodical publication provides a website or other on-line service to advertising customers, and customers may prepare ads for inclusion in the periodical and/or community calendar.

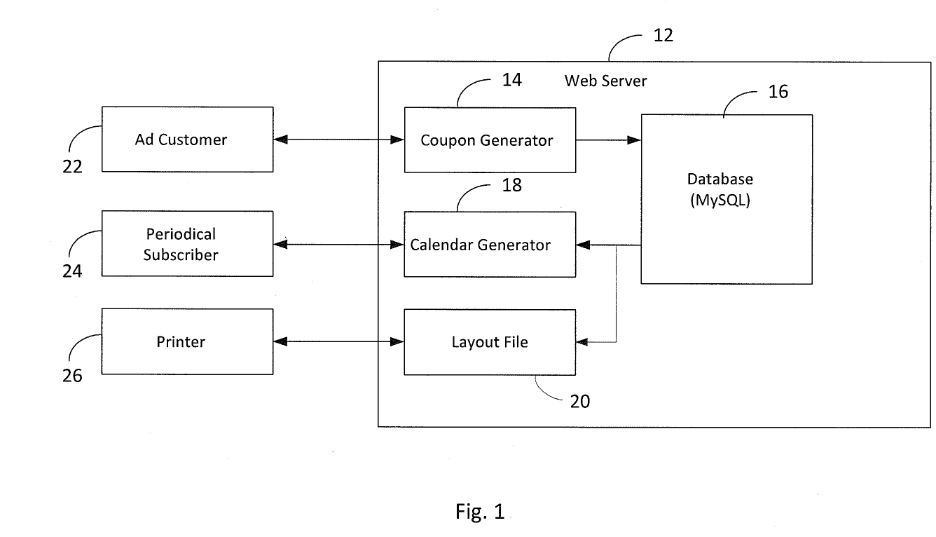

FIG. 1 illustrates one example of a coupon generator system 10 and its environment. Coupon generator system 10 may comprise a web server 12 including a Coupon/Flash/Splash Generator 14, a database 16, a calendar generator 18 and a Flash PDF generator 20. The Coupon/Flash/Splash Generator 14 is configured to draw customer information from the database 16 and insert coupon information and images into the database 16. The calendar generator 18 and Flash PDF generator 20 are configured to draw coupon information and images from the database 16.

The web server 12 may comprise any conventional World Wide Web server, such as an Apache server, coupled to the Internet. An Advertiser 22 may access the Coupon/Flash/Splash Generator 14 via a network, such as the Internet. Periodical readers 24 may also access calendars populated by the calendar generator 18 and other on line publications via the network.

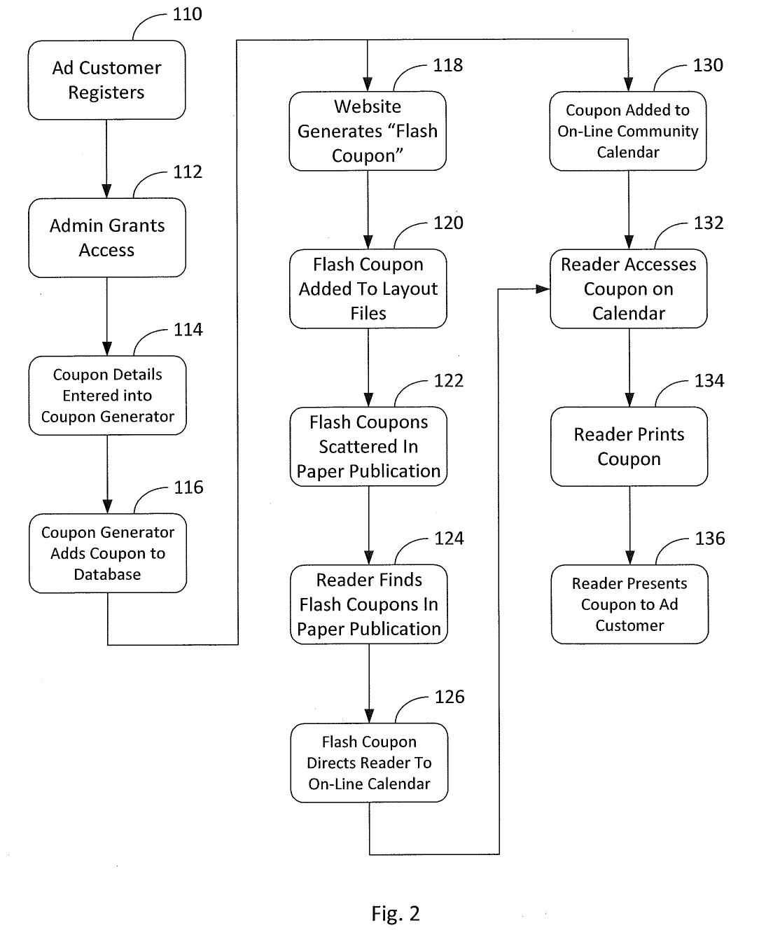

Referring to FIG. 2, a method 100 of using a Coupon Generator System 10 is illustrated. The following steps may be performed:

Step 110. An Advertiser registers for a Coupon generator system 10 account on the Periodical's website. Alternately, as an accommodation to a good customer or for an additional fee, Staff may register the Advertiser. As part of the registration process, the Advertiser must provide Advertiser's (a) name; (b) logo (if applicable); (c) “tag line” (if applicable); (d) address; (e) phone number (if applicable); (f) e-mail address (if applicable); (g) website URL (if applicable); (h) bar or QR code (if applicable); and (i) contact person (if applicable) (collectively “Advertiser Details”).

Step 112. Staff must approve the Advertiser's account. This allows for credit checks, standards verification and abuse prevention. Once approved, Advertiser Details are added to the coupon generator system's SQL database. Registration and approval need be done only once. Staff can terminate an Advertiser's use of the Coupon generator system for failure to pay bills, violation of decency standards, abuse, etc.

Step 114. Advertiser logs in to the coupon generator system 10 to enter (a) coupon start date (direct entry or clicking a calendar); (b) coupon expiration date (direct entry or clicking a calendar); (c) summary offer (e.g. “free soda”; limited number of characters); (d) full offer (e.g. “free soda with purchase of $10 or more”); and (e) disclaimer (e.g. “one soda per person”). In most cases, the coupon start date and coupon expiration date will be the same (e.g. Tuesday). Once the coupon generator system's form has been filled out, Advertiser clicks [Preview]. If the form has not been filled out completely, the Advertiser is alerted to missing or incomplete data. The coupon generator system 10 will not allow the Advertiser to proceed until the form is complete.

Clicking [Preview] brings up a preview of the coupon, which is a pre-populated GIF file of what a consumer will see if the consumer wishes to print the coupon (“Coupon GIF”). In addition to the items the Advertiser entered in the coupon generator system form (coupon start date; coupon expiration date (if the expiration date is the same as start date, only one date is shown); full offer; and disclaimer) the Coupon GIF file contains the Advertiser Details drawn from the SQL database. The coupon generator system 10 uses PHP code on the server side to dynamically place that textual information on top of a GIF image depicting a blank coupon to create the Coupon GIF, which will look like a traditional coupon.

If the Advertiser does not like the Coupon GIF, the Advertiser clicks [EDIT] and reverts to the coupon generator system form. If the Advertiser likes the Coupon GIF, the Advertiser clicks [SUBMIT]. An Advertiser can create as many coupons as desired.

Depending on how the Advertiser fills out the coupon generator system form, Splashes may be displayed one specific day (e.g. next Tuesday), over a span of days (e.g. March 1 to March 15) or recur (e.g. every Monday).

Alternately, as an accommodation to a good customer or for an additional fee, an Advertiser may telephone, email, or otherwise provide information to Staff, and Staff may then login as the Advertiser and create a coupon.

Step 116. The coupon generator system 10 adds the coupon information to the SQL database. The Advertiser can no longer edit or change the coupon. If needed, Staff has access to the SQL database to correct errors, make edits or delete the coupon information.

Step 118. The coupon generator system 10 generates a Flash. A Flash is a small, less than an inch in diameter, image depicting a graphic such as a star or bubble containing solely the Advertiser's name and coupon date. Print readers would be conditioned to know the Flash referred to an Advertiser's coupon on that date in the Periodical's online or mobile calendar or online or mobile coupon page. The coupon generator system 10 uses PHP code on the server side to dynamically place that textual information to create the Flash, which is then converted via PHP to a PDF file (“Flash PDF”).

Step 120. The Flash PDF is automatically added to the file that a separate system has created that contains all human-produced traditional print advertising graphic files as well as other Flash PDFs, editorial content and photos. Only Flash PDFs with start dates through expiration dates that include the coming week's printed-Periodical are included in the zip file. When the person or system laying out a print version of the Periodical goes to download all the ads, editorial content and photos for the particular week from the SQL database, these Flash PDFs would be included in the zip file. The Flash PDFs would be used to fill holes in the paper on an as needed basis. Thus, the Flash PDFs fill otherwise un-used space in the printed periodical, and drive subscriber traffic to the Periodicals online or mobile publication.

Step 124. Reader sees a Flash in the Periodical

Step 126. Which conditions reader to visit the Periodical's online or mobile calendar or online or mobile coupon page.

Step 130. The coupon generator system 10 generates a Splash. A Splash is a clickable image containing a miniature version of the Advertiser's coupon with items (a), (b) and (c) from Step 110 and item (c) from Step 114. The coupon generator system 10 uses PHP code on the server side to dynamically place those items to create the Splash. The coupon generator system 10 uses PHP code on the server side to dynamically place the Splash on the Periodical's online and mobile calendar on the date specified in Step 114 (a) and repeats the Splash each day through the date specified in 114 (b). If Step 114 (a) and Step 114 (b) are the same dates, there would be only one Splash. For example, a florist might want its Splash on the calendar on the same day as the senior prom. The coupon generator system 10 uses PHP code on the server side to dynamically place the Splash on the Periodical's online and mobile coupon page ordered first chronologically and then alphabetically. The coupon generator system 10 uses PHP code on the server side to dynamically remove the Splash after its expiration date specified in Step 114 (b).

Step 132. The print, online or mobile reader browses to the Periodical's online or mobile community calendar and sees Splashes amongst community calendar items in sequential date-contextual order. The print, online or mobile reader browses to the Periodical's online or mobile coupon page and sees Splashes in chronological then alphabetical ordered.

Step 134. Clicking on a Splash takes the consumer to a new page, which has the Coupon GIF and a print button so that the reader can print the coupon.

Step 136. The reader presents the printed coupon to the Advertiser for redemption.

A Splash or PHP resized Coupon GIF may also be shown throughout the Periodical's website as a banner ad. Clicking on such banner ad takes the consumer to a new page, which has the Coupon GIF and a print button so that the reader can print the coupon as in Step 134.

The coupon generator system 10 tracks the date the Advertiser creates a coupon and the number of coupons the Advertiser creates for invoicing purposes. The coupon generator system 10 also tracks the number of consumers who click Splashes and print Coupon GIFs.

What is claimed is:

1. A coupon generator system, comprising:
a. a coupon/Flash/Splash generator, configured to receive coupon information and generate coupon images and information regarding coupons;
b. a database; configured to receive images and information from the coupon generator;
c. a calendar generator, configured to draw information and images from the database and generate a publicly-accessible calendar with coupons; and
d. a Flash PDF generator, configured to draw information from the database and generate flash coupon files for print media.

2. The system of claim 1, wherein the system further comprises a web server coupled to the Internet.

3. The system of claim 2, further comprising an on-line community calendar configured to receive content from the calendar generator.

4. The system of claim 1, wherein coupon generator is configured to receive coupon specific information from a user, draw customer-specific information from the database, and combine textual information with a coupon image blank to create a coupon.

5. The system of claim 1, wherein the Flash PDF files comprise PDF files.

6. A method of automatically generating coupons for a plurality of media, comprising:
a. creating an advertising account, the advertiser account including advertiser details;
b. adding the advertiser details to a database;
c. entering coupon details, including a start date and an expiration date, into a coupon generator;
d. the coupon generator creating a coupon image including the coupon details and selected advertiser details;
e. adding the coupon information to the database;
f. generating a flash coupon for printed publications from coupon information in the database;
g. determining a relevant time period for a printed periodical;
h. adding the flash coupon to a file that contains print advertising graphic files, editorial content and photos for the printed periodical if start date through expiration date falls within the relevant time frame;
i. generating a clickable image splash coupon
j. dynamically placing the splash coupon in online editions of the periodical and online calendar on the dates corresponding to the start date and expiration date.
